(19) United States
(12) Patent Application Publication
(10) Pub. No.: US 2005/0011082 A1
(43) Pub. Date: Jan. 20, 2005

(54) Tape measure device

(76) Inventor: Michael J. Smith, Indianapolis, IN (US)

Correspondence Address: BARNES & THORNBURG, 11 SOUTH MERIDIAN, INDIANAPOLIS, IN, 46204, US

(21) Appl. No.: 10/890,287

(22) Filed: Jul. 13, 2004

Related U.S. Application Data
(60) Provisional application No. 60/487,030, filed on Jul. 14, 2003.

(51) Int. Cl. G01B 3/10

(52) U.S. Cl. 33/758

(57) ABSTRACT

A tape measuring device for measuring the distance between a golf ball and a pin or flagstick of a golf hole of a golf course includes a measuring tape strip and a coupler configured to couple to the pin or flagstick. The coupler be secured to the measuring tape strip by a fastener.

This application claims priority under 35 U.S.C. § 119(e) to U.S. Provisional Application Ser. No. 60/487,030, filed on Jul. 14, 2003, the entirety of which is hereby incorporated by reference herein.

### FIELD OF THE DISCLOSURE

The present disclosure is related to a tape measure device and particularly to an end piece or coupler coupled to an end of a measuring tape strip of the tape measure device.

### BACKGROUND

Tape measure devices generally include a housing and a measuring tape strip coupled to the housing and extendable from and retractable into the housing. Many tape measures are also equipped with a generally “L-shaped” hook at the end of the tape strip. This “L-shaped” hook provides a downward right angle at the end of the tape strip such that when measurements are being taken, the “L-shaped” hook may be used to hook onto the edge of an object. With this right angle hook, the end of the tape strip is held in position at the edge of the object, eliminating the need for manually holding the end of the tape strip in position.

Tape measures are used in many applications. For example, golfers often use tape measures to determine the distance between a golf ball and a particular hole of a golf course or other green. Many golfers have played a game where the object of the game is to determine who among the competitors is able to position their golf ball the closest to the pin or flagstick of the particular hole which is being played. Traditionally, in a golf outing, for example, golfers may each write their name on a stake and place the stake at the position of the golf ball each time his or her golf ball appears to be closer than the previously staked position. This practice, however, may cause damage to a putting green due to the number of stakes driven into and removed from the ground around the hole. Further, this practice may not be entirely accurate. For example, it is often difficult to determine whose golf ball actually is the closest to the pin.

### SUMMARY

The present invention comprises one or more of the features recited in the appended claims or one or more of the following features or combinations thereof.

A tape measure or measuring device for measuring a distance between a golf ball and a pin or flagstick of a golf hole of a golf course may include a measuring tape strip and a coupler configured to couple to the pin or flagstick. The measuring device may further include a tape measure housing. The measuring tape strip is coupled to and extendable from the tape measure housing. The measuring tape strip may also be manually or automatically retractable into the tape measure housing.

The coupler may be embodied as a hook, clamp, clip, or other device couplable to the pin or flagstick. In one embodiment, the coupler is embodied as a “J-shaped” hook. The “J-shaped” hook may include an elongated portion and a lip coupled to the elongated portion. The lip may be coupled to the elongated portion at an acute angle. The “J-shaped” hook may further include an intermediary portion coupled between and to the elongated portion and the lip. The lip may extend in a backward direction over the elongated portion and be generally parallel to the elongated portion. The intermediary portion may be curved or straight. The “J-shaped” hook may further include a securing member coupled to the elongated portion. A fastener may couple the securing member of the “J-shaped” hook to the measuring tape strip. The fastener may be made of a flexible material such as nylon and may be secured to the tape measure by stitches, rivets, clamps, buttons, hook-and-loop materials, glue, or other suitable securing means.

A user of the measuring device, such as a golfer, may use the device to measure the distance between a pin and a golf ball by coupling the coupler of the measuring device to the pin and, while holding the tape measure housing, extending the device away from the pin towards the golf ball. Once the golf ball is reached, the user may determine the distance between the pin and the golf ball by reading the measuring tape strip. The user may then repeat the measuring process for other golf balls by rotating the measuring device around the pin to the general position of the other golf balls and extending or retracting the measuring tape strip as needed.

The above and other features of the present disclosure will become apparent from the following description and the attached drawings.

### BRIEF DESCRIPTION OF THE DRAWINGS

The detailed description particularly refers to the accompanying drawings in which:

FIG. 1 is a perspective view of a tape measuring device of the present disclosure showing a tape measure housing, a measuring tape strip retractably extending from within the housing, and a coupler illustratively embodied as a “J-shaped” hook secured to a first end of the measuring tape strip;

FIG. 2 is a perspective view of the measuring device in use showing the coupler coupled to a pin or flagstick of a golf hole and showing the measuring tape strip extending between the golf ball and the pin so that the golfer is able to accurately measure the distance of the golf ball from the pin;

FIG. 3 is a perspective view of a hook of the illustrative coupler of the device hooked around the pin; and

FIG. 4 is a perspective view of the housing of the device and a portion of the measuring tape strip of the device showing the measuring tape strip extended out to a golf ball to measure the distance of the golf ball from the pin.

### DETAILED DESCRIPTION OF THE DRAWINGS

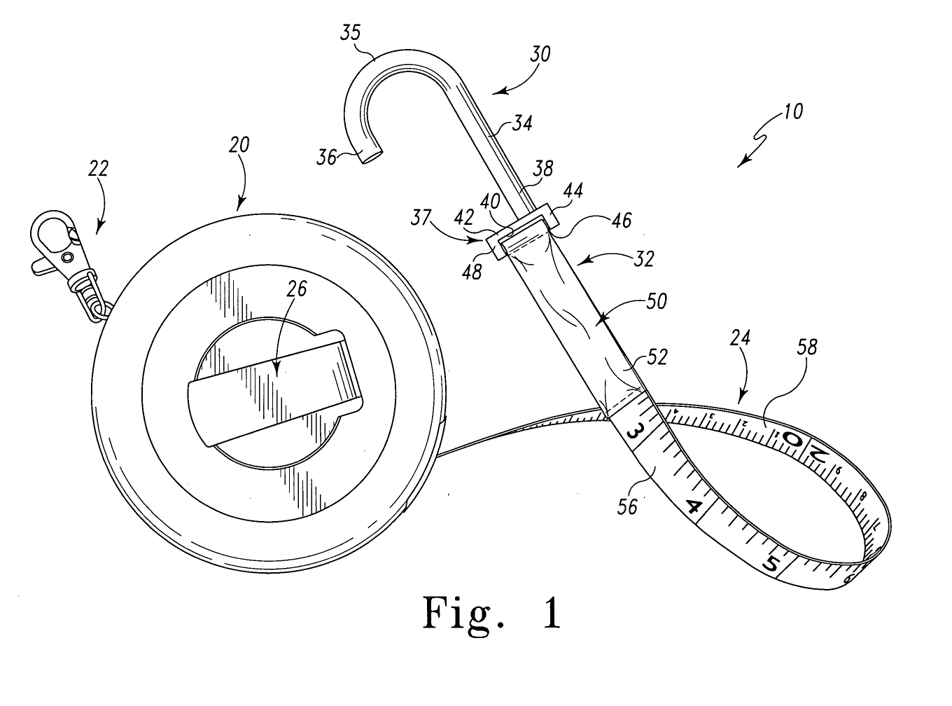

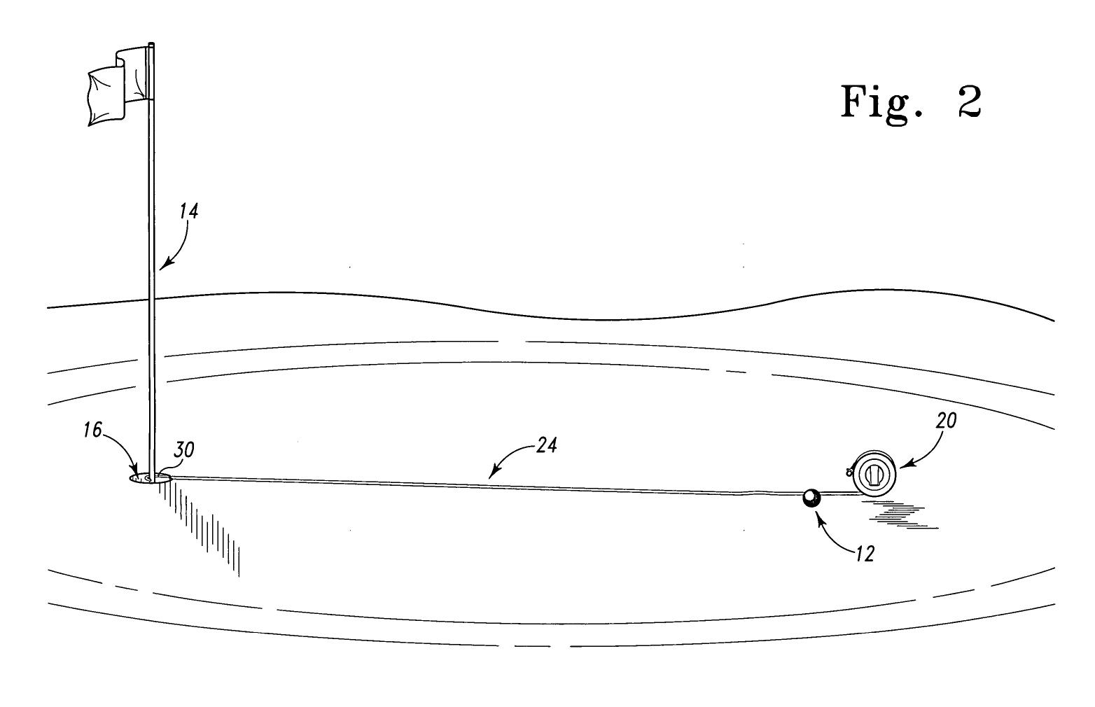

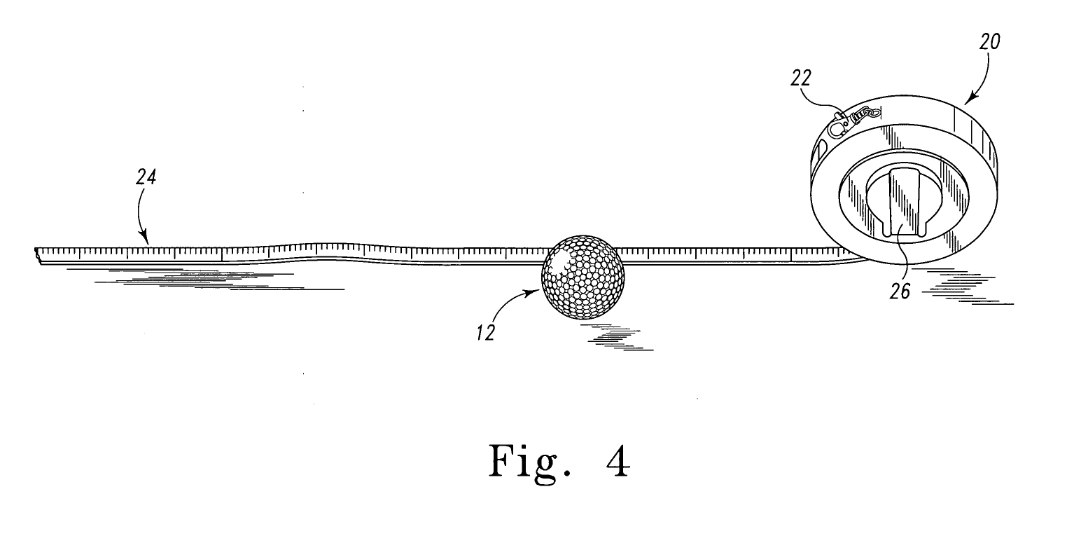

A tape measure or tape measuring device 10 is provided for measuring the distance between a golf ball 12 and a pin 14 of a hole 16 on a golf course (as shown in FIGS. 2-4), miniature golf course, indoor putting green, or any such suitable golf ball hole, for example. It is within the scope of this disclosure, however, to use tape measuring device 10 to measure the distance between any two objects and/or to measure any particular dimension (i.e. length, width, height, diameter, etc.) of an object. Illustrative device 10 includes a tape measure housing 20, a clip 22 coupled to housing 20, and a measuring tape strip 24 normally contained within housing 20, as shown in FIG. 1. Measuring tape strip 24 is extendable and retractable with respect to housing 20. Illustrative clip 22 is coupled to housing 20 and may be attached to a golfer's pants belt loop or golf bag, for example, to allow the golfer to more easily carry the device 10 around on the golf course. A hand-crank 26 of housing 20 is provided to manually retract the measuring tape strip 24 when the measuring tape strip 24 has been extended. In alternative embodiments, a push-button or other type of switch may replace the hand-crank 26. In such embodiments, the push-button is selectable by the golfer to automatically retract the tap measure 24 via, for example, spring tension.

Illustrative device 10 also includes a coupler 30 secured to a first end 32 of the measuring tape strip 24. A second end (not shown) of the measuring tape strip 24 is located within and coupled to the housing 20. The coupler 30 is configured to couple to objects having generally rounded surfaces, edges, or corners such as bars, rods, and the like and may be embodied as a hook, clamp, clip, or other coupling device. The coupler 30 may be made of any suitable material including, for example, metallic materials, plastic materials, or the like.

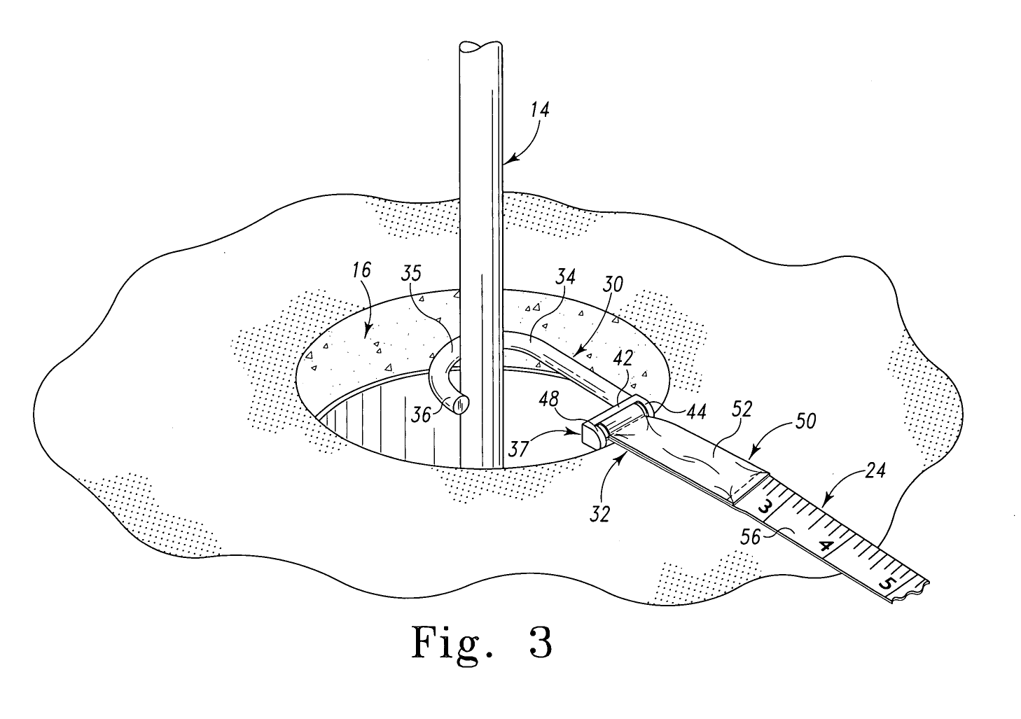

As illustrated in FIGS. 1 and 3, the illustrative coupler 30 is embodied as a “J-shaped” hook configured to couple to pin 14. However, the “J-shaped” hook illustrated in FIGS. 1 and 3, is only one exemplary embodiment of a “J-shaped” hook and, in other embodiments, other types of “J-shaped” hooks may be used. Typically, a “J-shaped” hook includes an elongated portion, an intermediary portion, and a lip. The elongated portion is formed at one end to be couplable to a measuring tape strip. The intermediary portion couples the lip to the elongated portion in a spaced-apart position so that the lip extends back over the elongated portion. The lip is generally parallel to the elongated portion and extends a length from the intermediary portion that is less than the length of the elongated portion to facilitate the coupling and decoupling of the “J-shaped” hook to objects. The intermediary portion may be relatively straight or have an inward curvature. However, in alternative embodiments, the “J-shaped” hook includes only an elongated portion and a lip. In such embodiments, the lip is secured to the elongated portion at an acute angle.

As illustrated in FIGS. 1 and 3, the illustrative coupler 30 includes an elongated portion 34, a curved intermediary portion 35 having an inner arcuate surface coupled to the elongated portion 34, and a lip 36 coupled to the curved intermediary portion 35. As mentioned above, intermediary portion 35 may also be linear or straight. A securing member 37 is coupled to an end 38 of the elongated portion 34 of the illustrative coupler 30. The illustrative securing member 37 is formed to define an aperture or slot 40 defined by first, second, third, and fourth, walls 42, 44, 46, 48.

The measuring device 10 further includes a fastener 50, as shown in FIG. 1, provided to secure the coupler 30 to first end 32 of the measuring tape strip 24. The illustrative fastener 50 is a flexible body having a first end 52 and a second end (not shown). The fastener 50 is threaded through the slot 40 of the coupler 30 so that the first end 52 is adjacent to and secured to a first side 56 of the measuring tape strip 24 and so that the second end (not shown) is adjacent to and secured to a second side 58 of the measuring tape strip 24 at the first end 32 of the tape strip 24. Illustratively, the first side 56 of the measuring tape strip 24 includes markings using the English unit of measure while the second side 54 of the tape strip 24 includes markings using the metric system, as shown in FIG. 1. Illustrative markings on the first side 56 are provided in inches and feet while illustrative markings on the second side 58 are provided in centimeters and meters.

The illustrative fastener 50 is made of nylon and is secured to the measuring tape strip 24 by a number of stitches. However, it is also within the scope of this disclosure to include a fastener 50 made of other suitable materials such as metal, fabric, or plastic materials and to attach the fastener 50 to the first end 32 of the measuring tape strip 24 using other suitable securing devices such as rivets, clamps, buttons, hook-and-loop materials, or glue, for example. Further, a thin piece of metal may be threaded through slot 40 and coupled to first end 32 of measuring tape strip 24, for example.

Illustratively, securing member 37 of the coupler 30 and fastener 50 cooperate with each other to provide a means for securing, coupling, or otherwise fastening the coupler 30 to the first end of a tape measuring device to provide a tape measuring device which may effectively be coupled to (e.g., hooked around) various objects such as pin or flagstick 14 shown in FIG. 2 without the need of a user to hold the first end of the tape measuring device stationary while a particular distance is measured. Further, the illustrative coupler 30 of the measuring device 10 is configured to allow a user or golfer to rotate the device 10 (once coupled to the pin 14) a full 360 degrees around the pin 14 to accurately measure multiple golf balls on the green and near the pin 14. For example, once the curved intermediary portion 35 and lip 36 of the illustrative coupler 30 are coupled to the pin 14, as illustrated in FIG. 3, the user may rotate the measuring device 10 around the pin 14. As the user rotates the device 10 around the pin 14, the curved intermediary portion 35 and lip 36 rotate around the pin 14 while remaining rotatably coupled to the pin 14.

In use, as shown in FIGS. 2-4, a golfer couples the coupler 30 to the pin 14 of the particular hole 16 from which the distance of the golf ball or balls 12 is to be measured. For example, a golfer may hook the curved intermediary portion 35 and lip 36 of the illustrative coupler 30 around the pin 14. While holding the housing 20, the golfer then extends the housing 20 of the device 10 away from the pin 14 towards the ball 12 and reads the distance, as marked on the measuring tape strip 24, of the ball 12 from the pin 14. As mentioned above, the measuring tape strip 24 illustratively provides that the distance may be measured using the English or metric systems. Once the distance between the pin and one particular golf ball 12 has been measured, the user or golfer simply moves the housing 20 toward a second golf ball and measures the distance between the second golf ball and the pin 14. The coupler 30 provides that the first end 23 of the measuring tape strip 24 remains rotatably coupled to the pin 14.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the measuring device described herein. It will be noted that alternative embodiments of the measuring device of the present disclosure may not include all of the features described yet still benefit from at least some of the advantages of such features. Those of ordinary skill in the art may readily devise their own implementations of the measuring device that incorporate one or more of the features of the present invention and fall within the spirit and scope of the present disclosure as defined by the appended claims.

1. A tape measuring device for measuring a distance between a golf ball and a pin, the tape measuring device comprising:
a measuring tape strip having a first and second end; and
a coupler configured to couple to the pin, the coupler being secured to the first end of the measuring tape strip.

2. The tape measuring device of claim 1, wherein the coupler is a “J-shaped” hook.

3. The tape measuring device of claim 2, wherein the “J-shaped” hook includes a curved portion configured to couple to the pin.

4. The tape measuring device of claim 1, wherein the coupler is configured to rotatably couple to the pin.

5. The tape measuring device of claim 1, further comprising a tape measure housing, wherein the second end of the measuring tape strip is coupled to the tape measure housing.

6. The tape measuring device of claim 5, wherein the measuring tape strip is automatically retractable into the tape measure housing.

7. The tape measuring device of claim 5, further comprising a handle coupled to the tape measure housing for manually retracting the measuring tape strip into the tape measure housing.

8. The tape measuring device of claim 1, further comprising a flexible fastener coupled to the coupler and the measuring tape strip.

9. The tape measuring device of claim 8, wherein the fastener is secured to the measuring tape strip by a number of stitches.

10. The tape measuring device of claim 8, wherein the fastener is made of a nylon material.

11. The tape measuring device of claim 1, wherein the coupler is made of a metallic material.

12. A tape measuring device for measuring a distance between a golf ball and a pin, the measuring device comprising:
a measuring tape strip; and
a “J-shaped” hook having a curved portion configured to couple to the pin, an elongated portion coupled to the curved portion, and a securing member coupled to the elongated portion and configured to be coupled to the measuring tape strip.

13. The tape measuring device of claim 12, wherein the securing member is formed to define an aperture.

14. The measuring device of claim 13, further comprising a fastener coupled to the securing member and the measuring tape strip, wherein a portion of the fastener is threaded through the aperture defined in the securing member.

15. The tape measuring device of claim 12, wherein the curved portion is configured to be rotatably coupled to the pin.

16. The tape measuring device of claim 12, further comprising a tape measure housing, wherein the measuring tape strip is extendable from and retractable into the tape measure housing.

17. A tape measuring device for attaching to a bar, the measuring device comprising
a measuring tape strip;
a coupler having a elongated portion, a lip spaced-apart from and generally parallel to the first elongated portion, and an intermediate member coupled to and positioned between the first and second elongated members, and
means for coupling the coupler to the measuring tape strip.

18. The tape measuring device of claim 17, wherein the means include a securing member and a fastener.

19. The tape measuring device of claim 17, wherein the intermediate portion includes an inner arcuate surface.

20. The tape measuring device of claim 17, wherein the intermediate portion is linear.
